(19) United States
(12) Patent Application Publication
(10) Pub. No.: US 2022/0108170 A1
(43) Pub. Date: Apr. 7, 2022

(54) METHOD FOR GENERATING TRAINING MODEL, IMAGE PROCESSING METHOD, IMAGE PROCESSING SYSTEM, AND WELDING SYSTEM

(71) Applicant: KABUSHIKI KAISHA TOSHIBA, Tokyo (JP)

(72) Inventors: Yasutomo SHIOMI, Koza (JP); Taisuke WASHITANI, Yokohama (JP)

(73) Assignee: KABUSHIKI KAISHA TOSHIBA, Tokyo (JP)

(21) Appl. No.: 17/346,706

(22) Filed: Jun. 14, 2021

(30) Foreign Application Priority Data
Oct. 2, 2020 (JP) 2020-167698

(51) Int. Cl. G06N 3/08; G06K 9/00; G06K 9/46

(52) U.S. Cl. CPC G06N 3/08; G06K 9/4609; G06K 9/00744

(57) ABSTRACT

A method for generating a training model includes: acquiring training data, the training data including a plurality of training input images, and a training feature extraction image in which a feature is extracted from one of the plurality of training input images; and training a training model by using the training data, the training model outputting an extraction image of the feature estimated from a plurality of input images, the training model including an input layer that performs a convolution, positions of the feature in the plurality of training input images being different from each other, a change amount of the position of the feature in the plurality of training input images being less than a kernel size of a filter of the input layer.

### CROSS-REFERENCE TO RELATED APPLICATIONS

This application is based upon and claims the benefit of priority from the prior Japanese Patent Application No. 2020-167698, filed on Oct. 2, 2020; the entire contents of which are incorporated herein by reference.

### FIELD

Embodiments relate to a method for generating training model, an image processing method, an image processing system, and a welding system.

### BACKGROUND

Conventional technology is known in which an extraction image of a feature is estimated from an input image by using a training model that is trained.

### BRIEF DESCRIPTION OF THE DRAWINGS

FIG. 1 shows a welding system according to a first embodiment;

FIG. 2A is a top view showing a welding member before welding;

FIG. 2B is a top view showing the welding member when welding;

FIG. 3 is a block diagram showing a configuration of hardware of a control device of the welding system according to the first embodiment;

FIG. 4 shows a training model according to the first embodiment;

FIG. 5 is a flowchart showing a method for generating the training model according to the first embodiment;

FIG. 6 shows data used to train the training model according to the first embodiment;

FIG. 7 shows a preprocessing method of a training input image that is included in the method for generating the training model according to the first embodiment;

FIG. 8 shows a generator of the training model according to the first embodiment;

FIG. 9A shows processing of an input layer of the training model according to the first embodiment;

FIG. 9B shows a convolution method of the input layer;

FIG. 10 shows contours of a molten pool that have mutually-different positions in the multiple training input images;

FIG. 11A shows processing of a first intermediate layer of the training model according to the first embodiment;

FIG. 11B shows processing of a second intermediate layer of the training model according to the first embodiment;

FIG. 11C shows processing of a third intermediate layer of the training model according to the first embodiment;

FIG. 12A shows processing of a fourth intermediate layer of the training model according to the first embodiment;

FIG. 12B shows processing of a fifth intermediate layer of the training model according to the first embodiment;

FIG. 12C shows processing of a sixth intermediate layer of the training model according to the first embodiment;

FIG. 13 shows processing of an output layer of the training model according to the first embodiment;

FIG. 14 shows a feature extraction image that is output by the generator of the training model according to the first embodiment;

FIG. 15 is a flowchart showing welding process that uses the training model according to the first embodiment;

FIG. 16 shows a portion of a welding system according to a second embodiment;

FIG. 17 shows a portion of a welding system according to a third embodiment; and

FIG. 18 shows a portion of a welding system according to a fourth embodiment.

### DETAILED DESCRIPTION

According to one embodiment, a method for generating a training model includes: acquiring training data, the training data including a plurality of training input images, and a training feature extraction image in which a feature is extracted from one of the plurality of training input images; and training a training model by using the training data, the training model outputting an extraction image of the feature estimated from a plurality of input images, the training model including an input layer that performs a convolution, positions of the feature in the plurality of training input images being different from each other, a change amount of the position of the feature in the plurality of training input images being less than a kernel size of a filter of the input layer.

According to one embodiment, an image processing method includes: acquiring a plurality of input images; and outputting an extraction image by using a trained model, the extraction image being of a feature estimated from the plurality of input images, the trained model including an input layer that performs a convolution, the trained model being trained using training data, the training data including a plurality of training input images, and a training feature extraction image in which the feature is extracted from one of the plurality of training input images, positions of the feature in the plurality of training input images being different from each other, a change amount of the position of the feature in the plurality of training input images being less than a kernel size of a filter of the input layer.

According to one embodiment, an image processing system includes: an image processor outputting an extraction image by using a trained model, the extraction image being of a feature estimated from a plurality of input images, the trained model including an input layer that performs a convolution, the trained model being trained using training data, the training data including a plurality of training input images, and a training feature extraction image in which the feature is extracted from one of the plurality of training input images, positions of the feature in the plurality of training input images being different from each other, a change amount of the position of the feature in the plurality of training input images being less than a kernel size of a filter of the input layer.

According to one embodiment, a welding system includes: a welder welding a welding member; at least one imaging device imaging a welding spot of the welding member; an image processor outputting an extraction image by using a training model, the extraction image being of a feature of a weld estimated from a plurality of images imaged by the imaging device; and a controller controlling the welder based on a feature extraction image output by the image processor, the trained model including an input layer that performs a convolution, the trained model being trained by using training data, the training data including a plurality of training input images, and a training feature extraction image in which the feature is extracted from one of the plurality of training input images, positions of the feature in the plurality of training input images being different from each other, a change amount of the position of the feature in the plurality of training input images being less than a kernel size of a filter of the input layer.

Various embodiments are described below with reference to the accompanying drawings.

### First Embodiment

First, a first embodiment will be described.

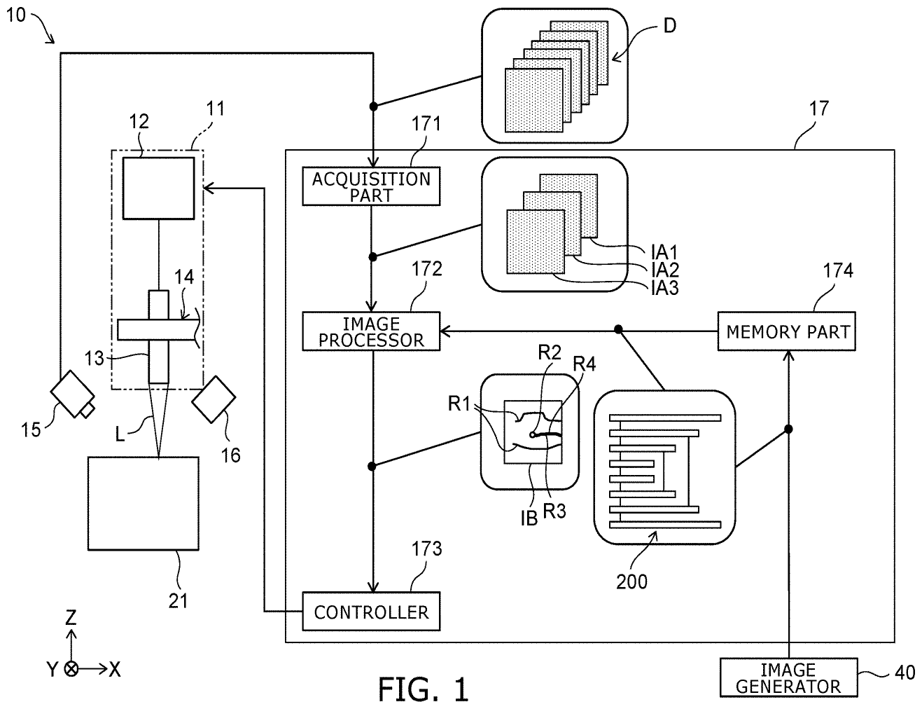

FIG. 1 shows a welding system according to the embodiment.

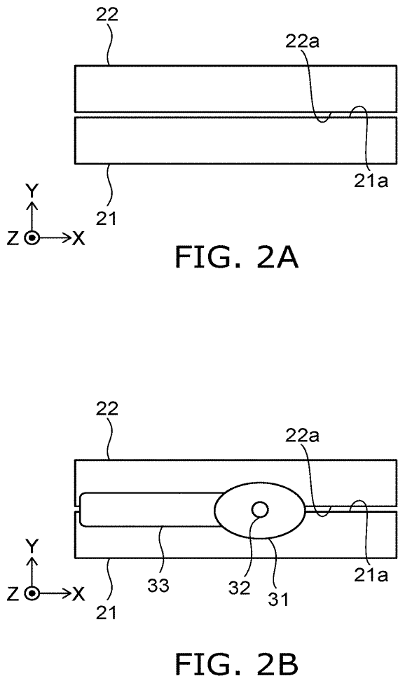

FIG. 2A is a top view showing a welding member before welding; and FIG. 2B is a top view showing the welding member when welding.

### Welding System

The welding system 10 according to the embodiment joins two or more welding members by welding. For example, the welding system 10 performs laser welding or arc welding. Mainly herein, an example is described in which the welding system 10 performs laser welding of two welding members 21 and 22 as shown in FIGS. 2A and 2B. Hereinbelow, the two welding members 21 and 22 also are called the “first welding member 21” and the “second welding member 22”.

The first welding member 21 and the second welding member 22 are, for example, plate-shaped members. The first welding member 21 and the second welding member 22 are disposed to face each other. Hereinbelow, the surface of the first welding member 21 that faces the second welding member 22 is called a “first surface 21a”; and the surface of the second welding member 22 that faces the first welding member 21 is called a “second surface 22a”.

As shown in FIG. 1, the welding system 10 includes, for example, a welder 11, an imaging device 15, a lighting device 16, and a control device 17.

Hereinbelow, an XYZ orthogonal coordinate system is used for easier understanding of the description. The direction from the first and second welding members 21 and 22 toward a head 13 is taken as a “Z-direction”. A direction that is orthogonal to the Z-direction from the first welding member 21 toward the second welding member 22 is taken as a “Y-direction”. A direction that is orthogonal to the Z-direction and the Y-direction and is in the travel direction of the head 13 is taken as an “X-direction”.

The welder 11 includes a light source 12, the head 13, and an arm 14. The head 13 is connected to the light source 12 and irradiates laser light L emitted by the light source 12 onto the first welding member 21 and the second welding member 22. The arm 14 holds the head 13 and moves the head 13 with respect to the first and second welding members 21 and 22. For example, the arm 14 is configured to move the head 13 in the X-direction, the Y-direction, and the Z-direction.

The imaging device 15 is, for example, a camera that includes a CCD image sensor or a CMOS image sensor. The imaging device 15 is located above the first welding member 21 and the second welding member 22. According to the embodiment, the imaging device 15 images a video image D of the welding spot when welding. Hereinbelow, the video image D also is called the “control video image D”.

The lighting device 16 illuminates the welding spot so that a clearer image is obtained by the imaging device 15. The lighting device 16 may not be provided if an image that is obtained without illuminating the welding spot can be used in the image processing by the image processing system described below.

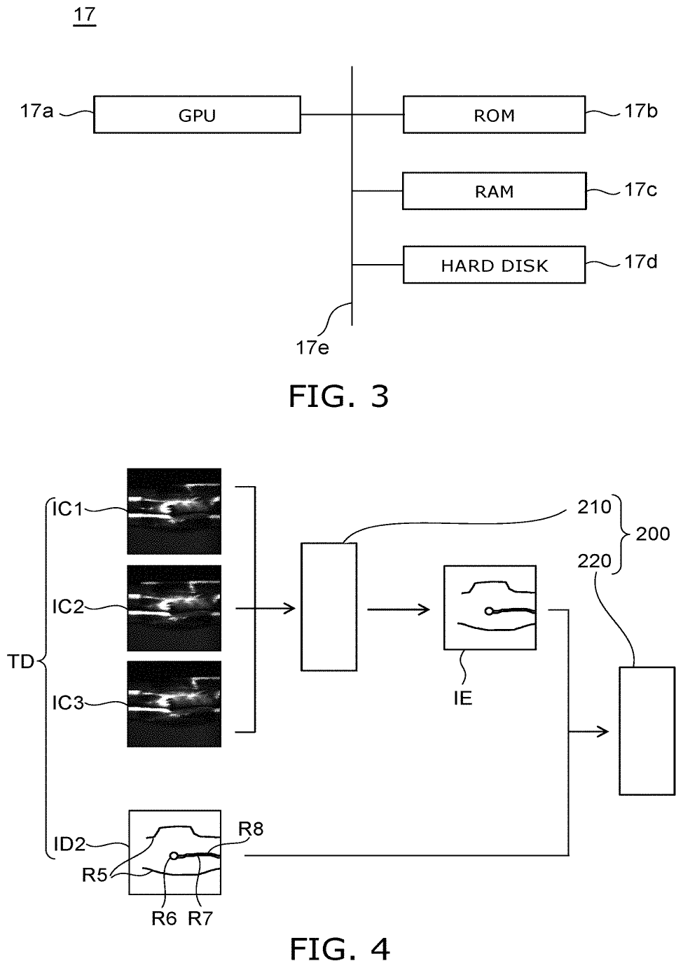

FIG. 3 is a block diagram showing the configuration of the hardware of the control device of the welding system according to the embodiment.

According to the embodiment, the control device 17 is a computer that includes a GPU (Graphics Processing Unit) 17a, ROM (Read Only Memory) 17b, RAM (Random Access Memory) 17c, a hard disk 17d, etc. The GPU 17a, the ROM 17b, the RAM 17c, and the hard disk 17d are connected to each other by a bus 17e. However, the configuration of the control device is not limited to that described above. For example, the control device may use another processor such as a CPU, etc., instead of the GPU. Also, the control device may include other configurations such as an input/output interface, etc.

According to the embodiment as shown in FIG. 1, the control device 17 functions as an acquisition part 171, an image processor 172, a controller 173, and a memory part 174. For example, the functions of the acquisition part 171, the image processor 172, and the controller 173 are realized by the GPU 17a. For example, the function of the memory part 174 is realized by the ROM 17b, the RAM 17c, the hard disk 17d, etc.

When welding the first welding member 21 and the second welding member 22, the controller 173 controls the welder 11 to move the head 13 in the X-direction while emitting the laser light L from the head 13 toward the first and second welding members 21 and 22. The controller 173 also controls the imaging device to image the video image D of the welding spot when welding.

By irradiating the laser light L on the first and second welding members 21 and 22, a portion of the first welding member 21 and a portion of the second welding member 22 are melted and a molten pool 31 forms as shown in FIG. 2B. The unmelted first and second surfaces 21a and 22a exist frontward of the molten pool 31 in the X-direction that is the travel direction of the head 13. There are cases where a keyhole 32 forms due to the melted metal evaporating at a region inside the molten pool 31 at which the energy density of the irradiated laser light L is high. Then, the first welding member 21 and the second welding member 22 are joined by the molten pool 31 solidifying. A weld bead 33 is formed at the joint between the first welding member 21 and the second welding member 22. Accordingly, one of the first surface 21a, the second surface 22a, the molten pool 31, the keyhole 32, or the weld bead 33 is included in each image included in the video image D.

As shown in FIG. 1, the acquisition part 171 acquires multiple images as multiple control input images IA1, IA2, and IA3 from the images included in the video image D at a prescribed time interval when welding. Here, although an example is described in which three control input images are used, the number of control input images is not particularly limited as long as the number is not less than 2. For example, the control input image IA3 is the newest image; and the control input image IA2 is imaged at a time directly before the control input image IA3. The control input image IA1 is imaged at a time directly before the control input image IA2. However, the control input image IA2 may not be imaged directly before the control input image IA3; and the control input image IA1 may not be imaged directly before the control input image IA2.

The image processor 172 uses a training model 200 that is trained and stored in the memory part 174 to output a feature extraction image IB that is estimated from the multiple control input images IA1, IA2, and IA3 at a prescribed time interval when welding. Hereinbelow, the feature extraction image IB also is called the “control feature extraction image IB”. The training model 200 that is trained also is called the “trained model 200”.

The feature that is extracted by the image processor 172 is the contour of a designated region inside the multiple control input images IA1, IA2, and IA3, etc. Here, an example is described in which the image processor 172 extracts multiple features. However, the number of features extracted by the image processor is not particularly limited as long as the number is not less than 1.

From the multiple control input images IA1, IA2, and IA3, the image processor 172 extracts the contour of the molten pool 31 as a line R1, extracts the contour of the keyhole 32 as a line R2, extracts the first surface 21a that is a portion of the contour of the first welding member 21 as a line R3, and extracts the second surface 22a that is a portion of the contour of the second welding member 22 as a line R4. In other words, the control feature extraction image IB is an image in which the contour of the molten pool 31 is shown as the line R1; the contour of the keyhole 32 is shown as the line R2; the first surface 21a is shown as the line R3; and the second surface 22a is shown as the line R4. However, the features that are extracted by the image processor are not particularly limited to those described above. For example, the image processor may extract the contour of the weld bead as a feature.

The controller 173 uses the control feature extraction image IB to control the welder 11 at a prescribed time interval. Specifically, the controller 173 calculates the shift between the Y-direction center position of the keyhole 32 and the Y-direction center position of the gap between the first surface 21a and the second surface 22a frontward of the keyhole 32 from the control feature extraction image IB and controls the arm 14 to eliminate the shift. Also, the controller 173 controls the output of the light source 12 so that the Y-direction position of the contour of the molten pool 31 in the control feature extraction image IB is outward of the first and second surfaces 21a and 22a and within a constant range. The positional accuracy of the weld of the first and second welding members 21 and 22 and the strength of the weld can be increased thereby.

### Training Model

The trained model 200 that is used in the welding system will now be described.

FIG. 4 shows the training model according to the embodiment.

The training model 200 that is used in the welding system is trained using training data TD.

The training data TD includes the multiple training input images IC1, IC2, and IC3, and a training feature extraction image ID2 in which a feature is extracted from one of the multiple training input images IC1, IC2, and IC3. The number of the training input images IC1, IC2, and IC3 that are used by the training model 200 in one training is equal to the number of the control input images IA1, IA2, and IA3 used in one image processing, e.g., three.

For example, the multiple training input images IC1, IC2, and IC3 are three images among the images included in the training video image in which the welding spot is imaged. For example, the training video image is imaged by the imaging device 15. For example, the training input image IC1 is imaged at a time directly before the training input image IC2; and the training input image IC3 is imaged directly after the training input image IC2. However, the imaging device of the training video image and the imaging device of the control video image D may be different from each other.

The training feature extraction image ID2 is, for example, an image in which a feature is extracted from the training input image IC2, and is prepared by the user of an image generator 40 that is described below before the training of the training model 200. Specifically, similarly to the control feature extraction image IB, the training feature extraction image ID2 is an image in which the contour of the molten pool 31 inside the training input image IC2 is shown as a line R5; the contour of the keyhole 32 is shown as a line R6; the first surface 21a is shown as a line R7; and the second surface 22a is shown as a line R8. For example, the creator generates the training feature extraction image ID2 by tracing the portions recognized as the contour of the molten pool 31, the contour of the keyhole 32, the first surface 21a, and the second surface 22a with lines in the training input image IC2 and by extracting the traced lines. However, the method for generating the training feature extraction image is not limited to that described above. Also, the training feature extraction image may be, for example, an image in which a feature is extracted from the training input image IC1 or the training input image IC3.

The algorithm that is used in the training model 200 is an algorithm that generates an image from an image, e.g., pix2pix.

The training model 200 includes a generator 210 and an identifier 220. The generator 210 outputs an extraction image IE of the feature estimated from the multiple training input images IC1, IC2, and IC3. When the pair of the training input image IC2 and the training feature extraction image ID2 and the pair of the training input image IC2 and the feature extraction image IE generated by the generator 210 are input, the identifier 220 identifies which of the pairs is the training data TD, i.e., genuine, and which of the pairs is not the training data TD, i.e., an imitation. The generator 210 is trained so that the identifier 220 identifies the pair of the training input image IC2 and the feature extraction image IE generated by the generator 210 to be genuine. The identifier 220 may be trained so that the pair of the training input image IC2 and the training feature extraction image ID2 is identified as genuine and the pair of the training input image IC2 and the feature extraction image IE generated by the generator 210 is identified as the imitation. The specific processing that is performed by the generator 210 and the identifier 220 is described below.

According to the embodiment as shown in FIG. 1, the training model 200 is generated by the image generator 40. The image generator 40 is a computer that includes a processor such as a GPU, a CPU, or the like, ROM, RAM, a hard disk, etc. However, the control device 17 may generate the training model.

### Method for Generating Training Model

A method for generating the training model 200 will now be described.

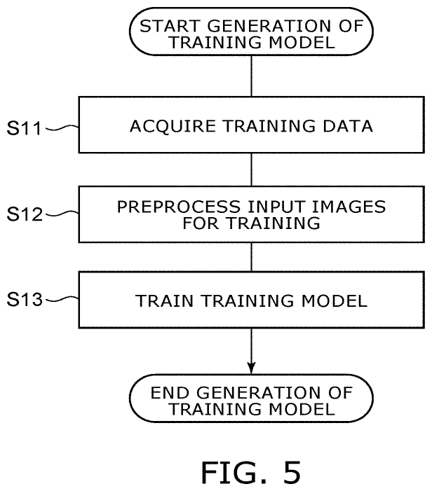

FIG. 5 is a flowchart showing the method for generating the training model according to the embodiment.

The method for generating the training model 200 includes a process S11 of acquiring the training data TD, a process S12 of preprocessing the training input images IC1, IC2, and IC3, and a process S13 of training the training model 200. The processes will now be elaborated.

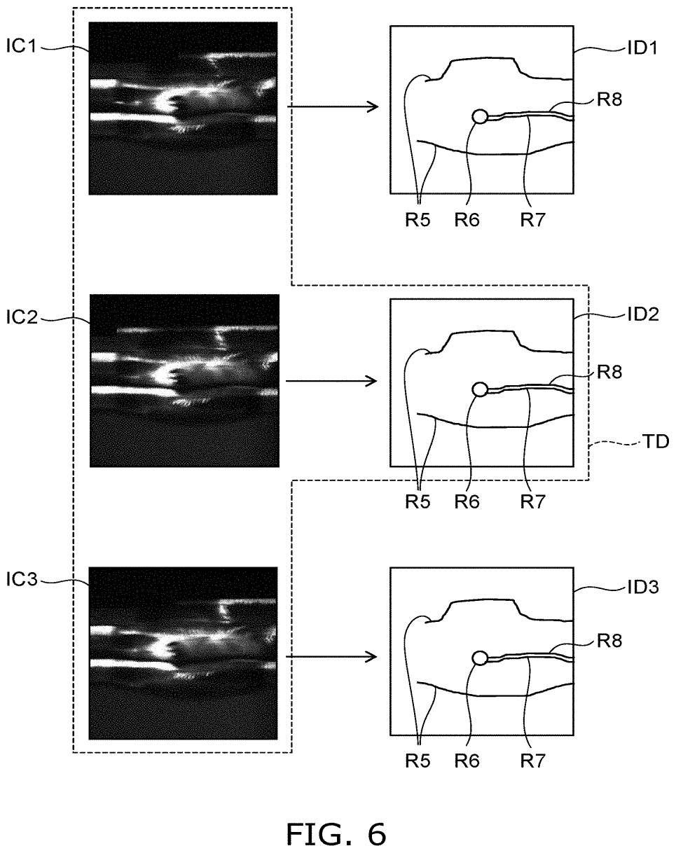

FIG. 6 shows the data used to train the training model according to the embodiment.

First, the image generator 40 acquires the training data TD that is prepared beforehand by the user (the process S11). In other words, the image generator 40 acquires the multiple training input images IC1, IC2, and IC3 and the training feature extraction image ID2 in which a feature is extracted from the training input image IC2.

According to the embodiment, the image generator 40 further acquires a preprocessing feature extraction image ID1 in which the features are extracted from the training input image IC1, and a preprocessing feature extraction image ID3 in which the features are extracted from the training input image IC3. Similarly to the training feature extraction image ID2, the preprocessing feature extraction images ID1 and ID3 are images in which the contour of the molten pool 31 is extracted as the line R5; the contour of the keyhole 32 is extracted as the line R6; the first surface 21a is extracted as the line R7; the line R8 is extracted as the second surface 22a; and the preprocessing feature extraction images ID1 and ID3 are prepared beforehand by the user. Similarly to the training feature extraction image ID2, the creator generates the preprocessing feature extraction images ID1 and ID3 by tracing the portions recognized as the contour of the molten pool 31, the contour of the keyhole 32, the first surface 21a, and the second surface 22a in the training input images IC1 and IC3 with lines and by extracting the traced lines.

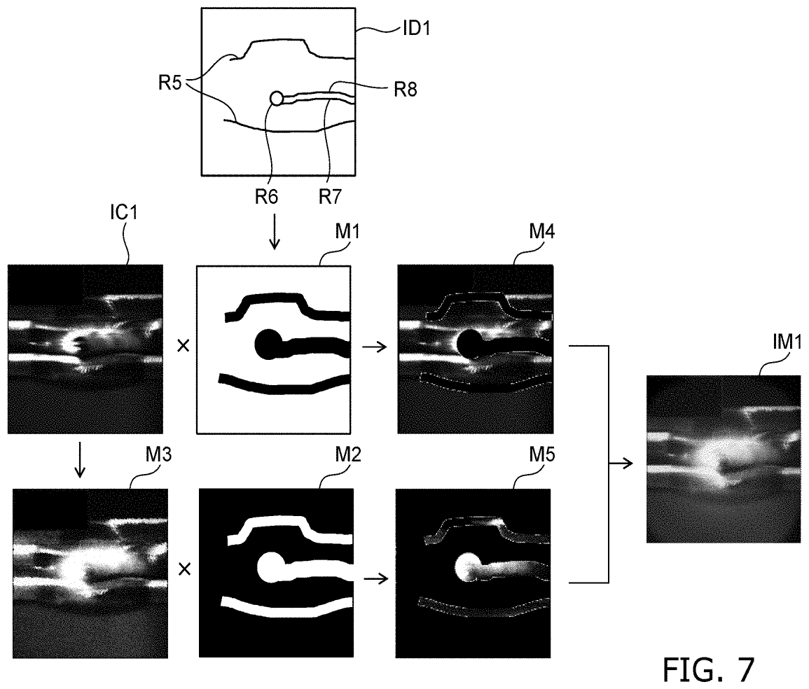

FIG. 7 shows a preprocessing method of the training input image that is included in the method for generating the training model according to the embodiment.

Then, the image generator 40 performs preprocessing of the training input images IC1, IC2, and IC3 (the process S12).

Specifically, the image generator 40 uses the preprocessing feature extraction image ID1 to generate a first mask M1 in which the values of the lines R5, R6, R7, and R8 and the values of the pixels around the lines R5, R6, R7, and R8 are set to zero, and the values of the other pixels are set to 1. Hereinbelow, the image also is considered to be a matrix; and the pixels also are called “elements”. The image generator 40 also generates a second mask M2 in which the values of the lines R5, R6, R7, and R8 and the values of the elements around the lines R5, R6, R7, and R8 in the preprocessing feature extraction image ID1 are set to 1, and the values of the other elements are set to 0. In the first and second masks M1 and M2 of FIG. 7, for easier understanding of the description, the elements for which the values are zero are shown in black; and the elements for which the values are 1 are shown in white.

Continuing, the image generator 40 multiplies the elements of the training input image IC1 and the first mask M1 with each other. Here, “multiply elements with each other” means processing that multiplies the element of the ith row and the jth column of one matrix and the element of the ith row and the jth column of the other matrix for all of the elements in two matrixes such as the training input image IC1 and the first mask M1, etc. Thereby, an image M4 is generated by removing the features and the region around the features from the training input image IC1.

Also, the image generator 40 generates an image M3 in which the entire training input image IC1 is blurred by applying a filter such as a smoothing filter, a Gaussian filter, a median filter, etc., to the training input image IC1. “Blur” means processing that reduces the change of the gradation inside the image. Then, the image generator 40 multiplies the elements of the second mask M2 and the image M3 that is entirely blurred. Thereby, an image M5 is generated by extracting the features and the regions around the features from the image M3 that is entirely blurred.

Then, the image generator 40 sums elements of the image M4 in which the training input image IC1 and the first mask M1 are multiplied and the image M5 in which the second mask M2 and the image M3 that is entirely blurred are multiplied. Here, “sum the elements” means processing that sums the element of the ith row and the jth column of one matrix and the element of the ith row and the jth column of the other matrix for all of the elements in two matrixes. A preprocessed image IM1 is generated thereby.

By performing processing such as that described above, the preprocessed image IM1 can be acquired in which the features and the regions around the features of the training input image IC1 are blurred, and the other regions are not blurred. The image generator 40 generates a preprocessed image IM2 of the training input image IC2 by performing similar processing of the training input image IC2. Also, the image generator 40 generates a preprocessed image IM3 of the training input image IC3 by performing similar processing of the training input image IC3.

In the process S12, the levels of blurring the multiple training input images IC1, IC2, and IC3 may be the same or may be different from each other. For example, the levels of blurring the training input images IC1, IC2, and IC3 can be adjusted using the values of weights when applying a filter such as a smoothing filter, a Gaussian filter, a median filter, etc. When the levels of the blur of the multiple preprocessed images IM1, IM2, and IM3 are different from each other, the training model 200 is trained so that the feature can be extracted for the preprocessed image that has the maximum blur level among the multiple preprocessed images IM1, IM2, and IM3.

However, an image in which the entire training input image is blurred may be used as the preprocessed image and input to the input layer of the training model described below. Also, a training input image on which preprocessing is not performed may be input to the input layer.

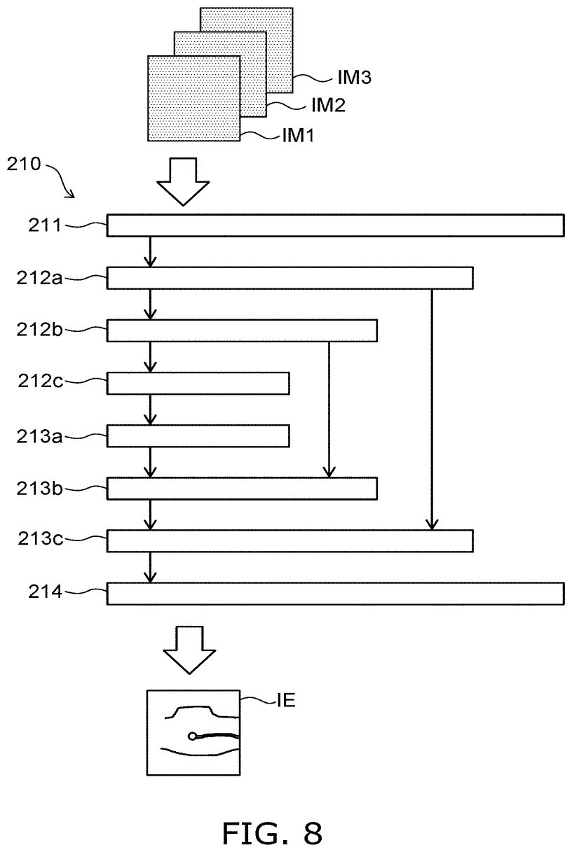

FIG. 8 shows a generator of a training model according to the embodiment.

Continuing, the image generator 40 trains the training model 200 by using the multiple preprocessed images IM1, IM2, and IM3 and the training feature extraction image ID2 (the process S13).

According to the embodiment, the generator 210 includes a U-NET. Specifically, according to the embodiment, the generator 210 includes an input layer 211, a first intermediate layer 212a, a second intermediate layer 212b, a third intermediate layer 212c, a fourth intermediate layer 213a, a fifth intermediate layer 213b, a sixth intermediate layer 213c, and an output layer 214. Although an example is shown in FIG. 8 in which the number of the intermediate layers 212a, 212b, 212c, 213a, 213b, and 213c is six, the number of intermediate layers is not limited to that described above.

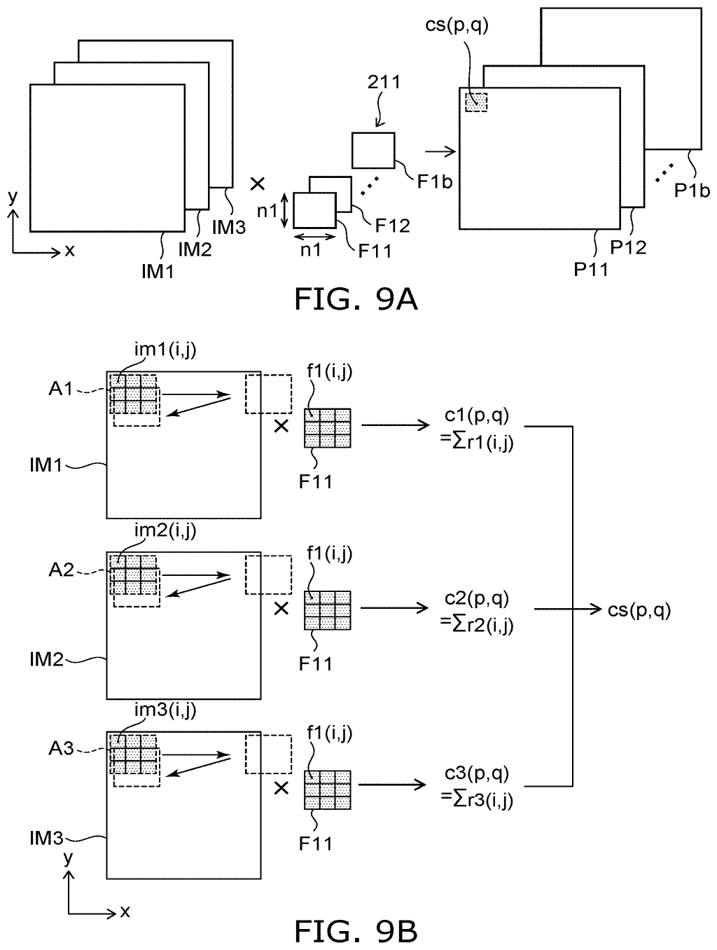

FIG. 9A shows processing of the input layer of the training model according to the embodiment; and FIG. 9B shows the convolution method of the input layer.

For easier understanding of the description hereinbelow, the direction in which the elements are arranged in one row in the matrix of an image, a filter, or the like is called a “lateral direction x”; and the direction in which the elements are arranged in one column is called a “vertical direction y”.

The multiple preprocessed images IM1, IM2, and IM3 are input to the input layer 211 as one set of data. Convolution of the one set of the preprocessed images IM1, IM2, and IM3 is performed in the input layer 211. Hereinbelow, an example is described in which the convolution is performed using b filters F11 and F12 to F1b in the input layer 211; and the kernel size of each filter F11 to F1b is n1×n1.

First, the image generator 40 extracts a region A1 that has the same size as the filter F11 in the preprocessed image IM1. Then, the image generator 40 calculates a value r1(i, j) by multiplying an element im1(i, j) of the ith row and jth column of the extracted region A1 and an element f1(i, j) of the ith row and jth column of the filter F11. The image generator 40 performs similar processing on all of the elements im1(i, j) inside the region A1. Then, the image generator 40 calculates a value c1(p, q) by summing all of the values r1(i, j) calculated for the region A1.

Similarly, the image generator 40 extracts a region A2 that has the same size as the filter F11 in the preprocessed image IM2 at a position similar to the region A1. Then, the image generator calculates a value r2(i, j) by multiplying an element im2(i, j) of the ith row and jth column of the extracted region A2 and the element f1(i, j) of the ith row and jth column of the filter F11. The image generator 40 performs similar processing for all of the elements im2(i, j) inside the region A2. Then, the image generator 40 calculates a value c2(p, q) by summing all of the values r2(i, j) calculated for the region A2.

Similarly, the image generator 40 extracts a region A3 that has the same size as the filter F11 in the preprocessed image IM3 at a position similar to the region A1. Then, the image generator calculates a value r3(i, j) by multiplying an element im3(i, j) of the ith row and jth column of the extracted region A3 and the element f1(i, j) of the ith row and jth column of the filter F11. The image generator 40 performs similar processing for all of the elements im3(i, j) inside the region A3. Then, the image generator 40 calculates a value c3(p, q) by summing all of the values r3(i, j) calculated for the region A3.

Continuing, the image generator 40 calculates a value cs(p, q) by summing the calculated values c1(p, q), c2(p, q), and c3(p, q).

Then, the image generator 40 similarly calculates the value cs(p, q) by sequentially shifting the regions A1, A2, and A3 to which the filter F11 is applied in the lateral direction x in the preprocessed images IM1, IM2, and IM3. When the regions A1, A2, and A3 have been shifted to the last row of the preprocessed images IM1, IM2, and IM3, the regions A1, A2, and A3 are returned to the initial row and shifted in the vertical direction y; and similar processing is performed. The processing described above is repeated until the regions A1, A2, and A3 are shifted to the elements of the preprocessed images IM1, IM2, and IM3 belonging to the last row and the last column.

According to the embodiment, the regions A1, A2, and A3 are shifted one element at a time in the lateral direction x or the vertical direction y in the input layer 211. In other words, the stride is 1. When shifting the regions A1, A2, and A3, zero padding is performed so that the values of the elements of the portions of the regions A1, A2, and A3 jutting outside the preprocessed images IM1, IM2, and IM3 are set to zero. However, the regions A1, A2, and A3 may be shifted two or more elements at a time. In other words, the stride may be not less than 2.

Thus, as shown in FIG. 9A, a first feature map P11 is generated in which the element of the pth row and qth column has the value cs(p, q). According to the embodiment as described above, the regions A1, A2, and A3 are shifted one element at a time in the lateral direction x and the vertical direction y. Therefore, the size of the first feature map P11 is equal to the sizes of the preprocessed images IM1, IM2, and IM3.

Then, processing similar to the filter F11 is performed for the filters F12 to F1b as well. Multiple first feature maps P12 to P1b are generated thereby. Thus, convolution of the three preprocessed images IM1, IM2, and IM3 is performed as one set of data in the input layer 211.

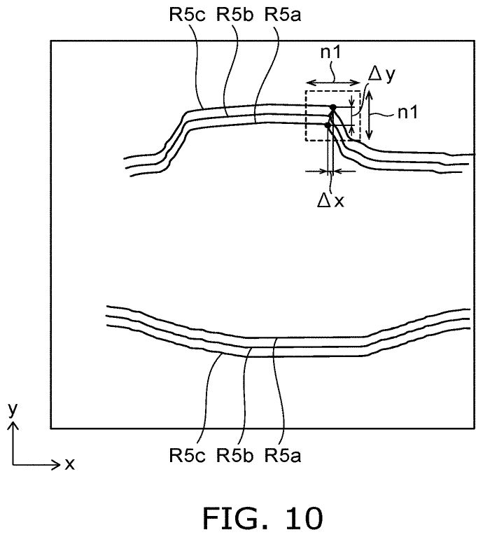

FIG. 10 shows contours of the molten pool that have mutually-different positions in the multiple training input images.

In FIG. 10, the position of the contour of the molten pool 31 of the training input image IC1 is shown by a line R5a; the position of the contour of the molten pool 31 of the training input image IC2 is shown by a line R5b; and the position of the contour of the molten pool 31 of the training input image IC3 is shown by a line R5c.

The multiple training input images IC1, IC2, and IC3 that are used are such that the positions of the feature are different from each other, and change amounts Δx and Δy of the position of the feature in the multiple training input images IC1, IC2, and IC3 are less than a kernel size n1 of the filters F11 to F1b.

For example, the molten pool 31 gradually spreads when the laser light L is continuously irradiated on a region of the first and second welding members 21 and 22. At this time, the positions of the contour of the molten pool 31 are different between the images included in the video image of the welding spot that is imaged by the imaging device 15.

According to the embodiment, a combination of the training input images IC1, IC2, and IC3 is selected from the images of the video image so that the maximum change amount Δx in the lateral direction x of the position of the contour of the molten pool 31 and the maximum change amount Δy in the vertical direction y of the position of the contour of the molten pool 31 are less than the kernel size n1 of the filters F11 to F1b. To perform such a selection, the time interval at which the imaging device 15 performs the imaging, i.e., the frame rate, is set so that the change amounts Δx and Δy of the position of the feature in the multiple training input images IC1, IC2, and IC3 are less than the kernel size n1 of the filters F11 to F1b. When the frame rate is fixed, the kernel size n1 may be reduced so that the change amounts Δx and Δy of the position of the feature in the multiple training input images IC1, IC2, and IC3 are less than the kernel size n1 of the filters F11 to F1b. Similarly, the angle of view may be increased.

The training input images IC1, IC2, and IC3 are selected to satisfy similar requirements also for other features, i.e., the contour of the keyhole 32, the first surface 21a, and the second surface 22a.

By selecting the multiple training input images IC1, IC2, and IC3 as described above, for example, when the feature is included in the region A1 that has the same size as the filter F11 in one training input image IC1, the likelihood is high that the feature is included in the regions A2 and A3 that have the same size as the filter F11 in the other training input images IC2 and IC3. Therefore, the training model 200 can be trained to estimate the extraction image IE of the feature from the multiple training input images IC1, IC2, and IC3 by including information relating to the change of the position of the feature in the multiple training input images IC1, IC2, and IC3. Thereby, even when it is difficult to extract the position of the feature by using one image, the position of the feature can be extracted with high accuracy from the change of the position of the feature in multiple images. As a result, the extraction accuracy of the feature when the multiple control input images IA1, IA2, and IA3 are input to the training model 200 can be increased.

According to the embodiment, an example is described in which the positions of the feature in the multiple training input images IC1, IC2, and IC3 are based on the elapse of time. In other words, according to the embodiment, the change amounts Δx and Δy are caused by the elapse of time. However, according to other embodiments described below, the change amounts may not be caused by the elapse of time.

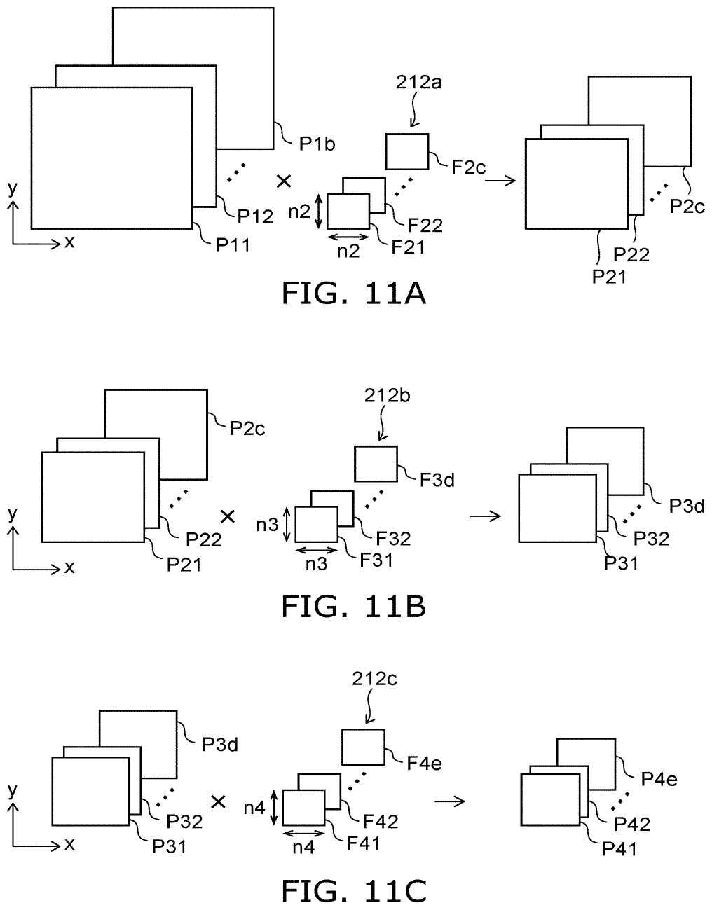

FIG. 11A shows the processing of the first intermediate layer of the training model according to the embodiment; FIG. 11B shows the processing of the second intermediate layer of the training model according to the embodiment; and FIG. 11C shows the processing of the third intermediate layer of the training model according to the embodiment.

Then, as shown in FIG. 11A, the multiple first feature maps P11 to P1b that are generated in the input layer 211 are input to the first intermediate layer 212a.

In the first intermediate layer 212a, the multiple first feature maps P12 to P1b are used as one set of data; and convolution is performed using c filters F21 and F22 to F2c. The specific method of the convolution is similar to the method of the convolution of the input layer 211 except that a region that has the same size as the filters F21 to F2c is shifted not less than two elements at time in the image on which the convolution is performed. Therefore, a detailed description of the convolution of the first intermediate layer 212a is omitted.

In the first intermediate layer 212a, the multiple second feature maps P21 and P22 to P2c are generated by performing convolution of the multiple first feature maps P12 to P1b by using the c filters F21 to F2c. According to the embodiment, the regions at which the filters F21 to F2c are applied are shifted not less than two elements at a time in the first feature maps P11 to P1b. Therefore, the size of the multiple second feature maps P21 to P2c is less than the size of the multiple first feature maps P12 to P1b.

Continuing as shown in FIG. 11B, in the second intermediate layer 212b, the multiple second feature maps P21 to P2c are used as one set of data; and convolution is performed using d filters F31 and F32 to F3d. d third feature maps P31 and P32 to P3d are generated thereby. According to the embodiment, the regions at which the filters F31 to F3d are applied are shifted not less than two elements at a time in the second feature maps P21 to P2c. Therefore, the size of the multiple third feature maps P31 to P3d is less than the size of the multiple second feature maps P21 to P2c.

Then, as shown in FIG. 11C, in the third intermediate layer 212c, the multiple third feature maps P31 to P3d are used as one set of data; and convolution is performed using e filters F41 and F42 to F4e. e fourth feature maps P41 and P42 to P4e are generated thereby. According to the embodiment, the regions at which the filters F41 to F4e are applied are shifted not less than two elements at a time in the third feature maps P31 to P3d. Therefore, the size of the multiple fourth feature maps P41 to P4e is less than the size of the multiple third feature maps P31 to P3d.

According to the embodiment, the change amounts Δx and Δy of the position of the feature in the multiple training input images IC1, IC2, and IC3 are less than a kernel size n2 of the filters F21 to F2c of the first intermediate layer 212a, a kernel size n3 of the filters F31 to F3d of the second intermediate layer 212b, and a kernel size n4 of the filters F41 to F4e of the third intermediate layer 212c. Therefore, it is easy for information relating to the change of the position of the feature included in the multiple first feature maps P11 to P1b to propagate from the first intermediate layer 212a to the third intermediate layer 212c.

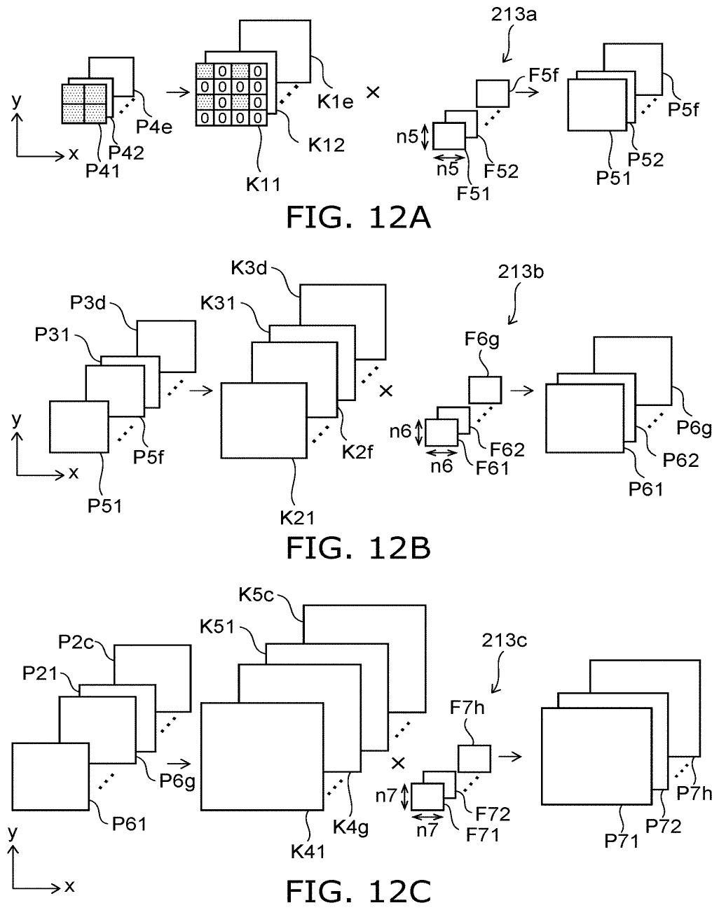

FIG. 12A shows the processing of the fourth intermediate layer of the training model according to the embodiment; FIG. 12B shows the processing of the fifth intermediate layer of the training model according to the embodiment; and FIG. 12C shows the processing of the sixth intermediate layer of the training model according to the embodiment.

Then, the multiple fourth feature maps P41 to P4e that are generated by the third intermediate layer 212c are input to the fourth intermediate layer 213a. In the fourth intermediate layer 213a, the multiple fourth feature maps P41 to P4e are used as one set of data; and deconvolution is performed. “Deconvolution” is processing in which it is assumed that the input feature map is generated by performing convolution of some map by using some filter, and by using the transposed matrix of that filter to perform a convolution of the input feature map.

Specifically, first, first enlarged maps K11 and K12 to K1e are generated by enlarging the size in the lateral direction x and the size in the vertical direction y of the fourth feature maps P41 to P4e. The enlarged maps K11 to K1e are generated by adding zero-value elements to the fourth feature maps P41 to P4e. Then, the multiple first enlarged maps K11, K12 and K13 to K1e are used as one set of data, and convolution is performed using f filters F51 and F52 to F5f. (fifth feature maps P51 and P52 to P5f are generated thereby. Here, the f filters F51 and F52 to F5f each correspond to the transposed matrix of some filter when it is assumed that the fourth feature maps P41 to P4e each are generated by performing a convolution of some map by using that filter. Thereby, the size of the multiple fifth feature maps P51 to P5f that are output can be greater than the size of the multiple fourth feature maps P41 to P4e that are input.

Then, as shown in FIG. 12B, the multiple fifth feature maps P51 to P5f that are generated by the fourth intermediate layer 213a and the third feature maps P31 to P3d that are generated by the second intermediate layer 212b are input to the fifth intermediate layer 213b. In the fifth intermediate layer 213b, the multiple fifth feature maps P51 to P5f and the third feature maps P31 to P3d are used as one set of data, and deconvolution is performed.

Specifically, in the fifth intermediate layer 213b, second enlarged maps K21 to K2f in which the size in the lateral direction x and the size in the vertical direction y of the multiple fifth feature maps P51 to P5f are enlarged are generated, and third enlarged maps K31 to K3d in which the size in the lateral direction x and the size in the vertical direction y of the multiple third feature maps P31 to P3d are enlarged are generated. Then, the multiple second enlarged maps K21 to K2f and the third enlarged maps K31 to K3d are used as one set of data, and convolution is performed using g filters F61 and F62 to F6g. g sixth feature maps P61 and P62 to P6g are generated thereby. The size of the multiple sixth feature maps P61 to P6g that are output is greater than the size of the multiple fifth feature maps P51 to P5f that are input.

Continuing as shown in FIG. 12C, the multiple sixth feature maps P61 to P6g that are generated by the fifth intermediate layer 213b and the second feature maps P21 to P2c that are generated by the first intermediate layer 212a are input to the sixth intermediate layer 213c. In the sixth intermediate layer 213c, the multiple sixth feature maps P61 to P6g and the second feature maps P21 to P2c are used as one set of data, and deconvolution is performed.

Specifically, in the sixth intermediate layer 213c, fourth enlarged maps K41 to K4g in which the size in the lateral direction x and the size in the vertical direction y of the multiple sixth feature maps P61 to P6g are enlarged are generated, and fifth enlarged maps K51 to K5c in which the size in the lateral direction x and the size in the vertical direction y of the multiple second feature maps P21 to P2c are enlarged are generated. Then, the multiple fourth enlarged maps K41 to K4g and the fifth enlarged maps K51 to K5c are used as one set of data, and convolution is performed using h filters F71 and F72 to F7h. h seventh feature maps P71 and P72 to P7h are generated thereby. The size of the multiple seventh feature maps P71 to P7h that are output is greater than the size of the multiple sixth feature maps P61 to P6g that are input.

According to the embodiment, the change amounts Δx and Δy of the position of the feature in the multiple training input images IC1, IC2, and IC3 are less than a kernel size n5 of the filters F51 to F5f of the fourth intermediate layer 213a, a kernel size n6 of the filters F61 to F6g of the fifth intermediate layer 213b, and a kernel size n7 of the filters F71 to F7h of the sixth intermediate layer 213c. Therefore, it is easy for information relating to the change of the position of the feature included in the multiple fourth feature maps P41 to P4e to propagate from the fourth intermediate layer 213a to the sixth intermediate layer 213c.

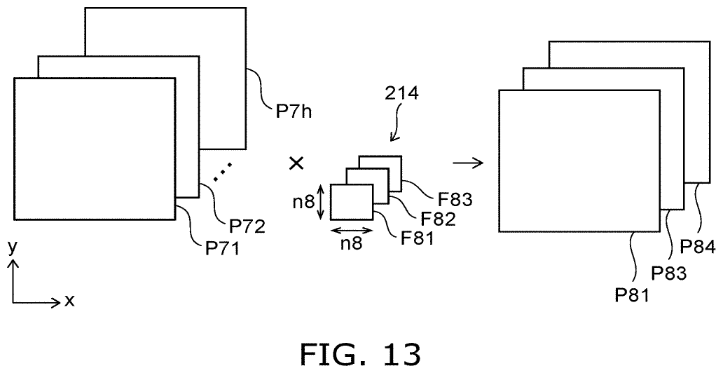

FIG. 13 shows the processing of the output layer of the training model according to the embodiment.

Then, as shown in FIG. 13, the multiple seventh feature maps P71 to P7h are used as one set of data, and convolution is performed using three filters F81, F82, and F83 in the output layer 214. Three eighth feature maps P81, P82, and P83 are generated thereby.

According to the embodiment, the change amount of the position of the feature in the multiple training input images IC1, IC2, and IC3 is less than a kernel size n8 of the filters F81 to F83 of the output layer 214. Therefore, the training model 200 can be trained to estimate the extraction image IE of the feature from the multiple training input images IC1, IC2, and IC3 by including the change of the position of the feature in the multiple training input images IC1, IC2, and IC3.

In the training model 200, for example, the number c of the filters F21 to F2c of the first intermediate layer 212a is greater than the number b of the filters F11 to F1b of the input layer 211. Also, the number d of the filters F31 to F3d of the second intermediate layer 212b is greater than the number c of the filters F21 to F2c of the first intermediate layer 212a. The number e of the filters F41 to F4e of the third intermediate layer 212c is greater than the number d of the filters F31 to F3d of the second intermediate layer 212b. The number f of the filters F51 to F5f of the fourth intermediate layer 213a is equal to the number e of the filters F41 to F4e of the third intermediate layer 212c. The number g of the filters F61 to F6g of the fifth intermediate layer 213b is equal to the number d of the filters F31 to F3d of the second intermediate layer 212b. The number h of the filters F71 to F7h of the sixth intermediate layer 213c is equal to the number c of the filters F21 to F2c of the first intermediate layer 212a. However, the size relationships of b to h are not limited to those described above.

In the training model 200, for example, the kernel size n1 of the input layer 211 is equal to the kernel size n8 of the output layer 214. For example, the kernel sizes n2 to n7 of the intermediate layers 212a, 212b, 212c, 213a, 213b, and 213c are equal to each other and are greater than the kernel size n1 of the input layer 211. However, the size relationship of the kernel sizes n1 to n8 is not limited to that described above.

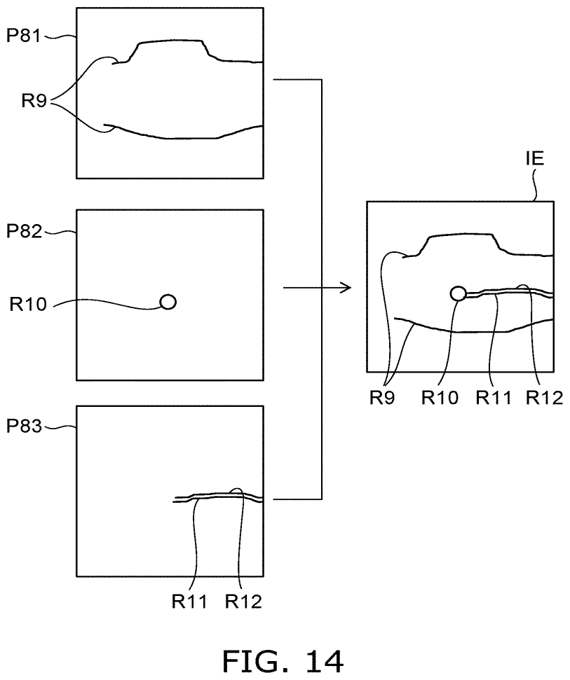

FIG. 14 shows the feature extraction image that is output by the generator of the training model according to the embodiment.

In the eighth feature map P81, the portion that is estimated to be the contour of the molten pool 31 is extracted as a line R9. In the eighth feature map P82, the portion that is estimated to be the contour of the keyhole 32 is extracted as a line R10. In the eighth feature map P83, the portion that is estimated to be the first surface 21a is extracted as a line R11; and the portion that is estimated to be the second surface 22a is extracted as a line R12. The combination of the three eighth feature maps P81, P82, and P83 corresponds to the extraction image IE of the features estimated from the multiple training input images IC1, IC2, and IC3.

Then, the pair of the training input image IC2 and the training feature extraction image ID2 and the pair of the training input image IC2 and the feature extraction image IE output by the generator 210 are input to the identifier 220. Then, the identifier 220 identifies which is the genuine pair and which is the imitation pair. The generator 210 is trained so that the identifier 220 identifies the pair of the training input image IC2 and the feature extraction image IE output by the generator 210 to be the genuine pair, and determines the values of the elements of the filters for performing the convolution and the deconvolution. Also, the training is performed so that the identifier 220 identifies the pair of the training input image IC2 and the training feature extraction image ID2 to be the genuine pair and the pair of the training input image IC2 and the feature extraction image IE output by the generator 210 to be the imitation pair. The training of the generator 210 and the training of the identifier 220 proceed by simultaneously performing the training of the two.

### Welding Process

A welding process that uses the training model 200 according to the embodiment will now be described.

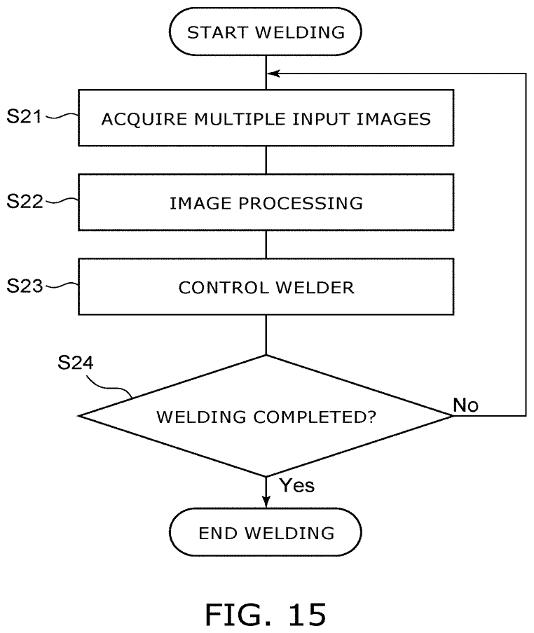

FIG. 15 is a flowchart showing the welding process that uses the training model according to the embodiment.

When welding in the following description, the controller 173 controls the welder 11 to emit the laser light L from the head 13 and to gradually move the head 13 in the X-direction. Also, when welding, the controller 173 controls the imaging device 15 to image the video image D of the welding spot when welding.

When the welding has started, first, the acquisition part 171 acquires the newest image and two images that are imaged at times directly before the newest image as the multiple control input images IA1, IA2, and IA3 from the images included in the video image D of the welding spot imaged by the imaging device (a process S21). According to the embodiment, the frame rate and the angle of view of the imaging device 15 are set so that the change amount of the position of the feature in the multiple control input images IA1, IA2, and IA3 is less than the kernel size n1 of the filters F11 to F1b of the input layer 211.

Then, the image processor 172 uses the training model 200 stored in the memory part 174 to output the extraction image IB of the feature estimated from the three input images IA1, IA2, and IA3 (a process S22).

Continuing, the controller 173 controls the welder 11 based on the feature extraction image IB output by the image processor 172 (a process S23). Specifically, the controller 173 calculates the shift of the Y-direction center position of the keyhole 32 and the Y-direction center position of the gap between the first surface 21a and the second surface 22a frontward of the keyhole 32 from the control feature extraction image IB and controls the arm 14 to eliminate the shift. Also, the controller 173 controls the output of the light source 12 so that the Y-direction position of the contour of the molten pool 31 is within a constant range and outward of the first and second surfaces 21a and 22a in the control feature extraction image IB.

Then, the controller 173 determines whether or not the weld is completed (a process S24). When the welding is determined to be completed (the process S24: Yes), the controller 173 sets the output of the laser OFF and completes the welding. When the welding is determined not to be completed (the process S24: No), the processing of the process S21 to S24 is performed again.

Effects according to the embodiment will now be described.

The method for generating the training model 200 according to the embodiment includes a process of acquiring the training data TD that includes the multiple training input images IC1, IC2, and IC3 and the training feature extraction image ID2 in which a feature is extracted from one of the multiple training input images IC1, IC2, and IC3, and includes a process of using the training data TD to train the training model 200 that outputs the extraction image IB of the feature estimated from the multiple input images IA1, IA2, and IA3. The training model 200 includes the input layer 211 that performs a convolution. The positions of the feature are different between the multiple training input images IC1, IC2, and IC3. The change amounts Δx and Δy of the position of the feature in the multiple training input images IC1, IC2, and IC3 are less than the kernel size n1 of the filters F11 to F1b of the input layer 211.

In such a method for generating the training model 200, the training model 200 can be trained to estimate the extraction image IE of the feature from the multiple training input images IC1, IC2, and IC3 from information that includes the change of the position of the feature between the multiple training input images IC1, IC2, and IC3. Therefore, the training model 200 can extract the feature with high accuracy when the multiple input images IA1, IA2, and IA3 are input.

The training model 200 includes the output layer 214 that performs a convolution. The change amounts Δx and Δy are less than the kernel size n8 of the filters F81, F82, and F83 of the output layer 214. Therefore, the training model 200 can be trained to estimate the extraction image IE of the feature from the multiple training input images IC1, IC2, and IC3 from information that includes the change of the position of the feature between the multiple training input images IC1, IC2, and IC3. Therefore, the training model 200 can extract the feature with high accuracy when the multiple input images IA1, IA2, and IA3 are input.

The training model 200 includes the intermediate layers 212a, 212b, and 212c that perform convolutions. The change amounts Δx and Δy are less than the kernel sizes n2, n3, and n4 of the filters F21 to F2c, F31 to F3d, and F41 to F4e of the intermediate layers 212a, 212b, and 212c. Therefore, the training model 200 can be trained to estimate the extraction image IE of the feature from the multiple training input images IC1, IC2, and IC3 from information that includes the change of the position of the feature between the multiple training input images IC1, IC2, and IC3. Therefore, the training model 200 can extract the feature with high accuracy when the multiple input images IA1, IA2, and IA3 are input.

The training model 200 includes the intermediate layers 213a, 213b, and 213c that perform deconvolutions. The change amounts Δx and Δy are less than the kernel sizes n5, n6, and n7 of the filters F51 to F5f, F61 to F6g, and F7 to F7h of the intermediate layers 213a, 213b, and 213c. Therefore, the training model 200 can be trained to estimate the extraction image IE of the feature from the multiple training input images IC1, IC2, and IC3 from information that includes the change of the position of the feature between the multiple training input images IC1, IC2, and IC3. Therefore, the training model 200 can extract the feature with high accuracy when the multiple input images IA1, IA2, and IA3 are input.

The training model includes a U-NET. In other words, the feature maps P21 to 2c and P31 to 3d that are output by the first intermediate layer 212a, the second intermediate layer 212b, etc., are input to deconvolution layers such as the fifth intermediate layer 213b, the sixth intermediate layer 213c, etc. Therefore, the training model 200 can extract the feature with high positional accuracy when the multiple input images IA1, IA2, and IA3 are input.

The method for generating the training model 200 according to the embodiment further includes a process of generating preprocessed images in which the feature is blurred in the multiple training input images IC1, IC2, and IC3 before the training process. The preprocessed images IM1, IM2, and IM3 are input to the input layer 211 in the training process. Therefore, the training model 200 can be trained so that the feature can be extracted even under challenging conditions in which the feature is blurred.

In the process of generating the preprocessed images, the level of blurring the feature in one training input image of the multiple training input images IC1, IC2, and IC3 is different from the level of blurring the feature in the other training input images of the multiple training input images IC1, IC2, and IC3. Therefore, the training model 200 can be trained so that the feature can be extracted even when the levels of blurring the feature are different.

The multiple training input images IC1, IC2, and IC3 are included in a video image of a welding spot corresponding to the object spot. Therefore, the multiple training input images IC1, IC2, and IC3 in which the positions of the feature are different from each other can be easily prepared.

One training input image of the multiple training input images IC1, IC2, and IC3 is imaged at a time that is directly before or directly after another training input image. Therefore, the multiple training input images IC1, IC2, and IC3 in which the change amounts Δx and Δy of the position of the feature are less than the kernel size n1 of the filters F11 to F1b can be easily prepared.

The multiple training input images IC1, IC2, and IC3 are images of a welding spot when welding; and the feature is at least a portion of the contour of the molten pool 31, at least a portion of the contour of the keyhole 32, or at least a portion of the contour of the welding members 21 and 22. Therefore, a feature that is relevant to welding can be extracted with high accuracy.

The trained model 200 according to the embodiment includes the input layer 211 that performs a convolution, and is trained using the training data TD that includes the multiple training input images IC1, IC2, and IC3 and the training feature extraction image ID2 in which the feature is extracted from one of the multiple training input images IC1, IC2, and IC3. The positions of the feature are different from each other between the multiple training input images IC1, IC2, and IC3; and the change amounts Δx and Δy of the position of the feature between the multiple training input images IC1, IC2, and IC3 are less than the kernel size n1 of the filters F11 to F1b of the input layer 211. The trained model 200 causes a computer to output the extraction image IB of the feature estimated from the multiple input images IA1, IA2, and IA3. Therefore, the trained model 200 can extract the feature with high accuracy when the multiple input images IA1, IA2, and IA3 are input.

The image processing method according to the embodiment includes a process of acquiring the multiple input images IA1, IA2, and IA3, and a process of using the trained model 200 to output the extraction image IB of the feature estimated from the multiple input images IA1, IA2, and IA3. Therefore, the image processing method can extract the feature with high accuracy when the multiple input images IA1, IA2, and IA3 are input.

The change amount of the position of the feature in the multiple input images IA1, IA2, and IA3 is less than the kernel size n1 of the filters F11 to F1b of the input layer 211. Therefore, the feature can be extracted with high accuracy when the multiple input images IA1, IA2, and IA3 are input.

The image processing system according to the embodiment includes the image processor 172 that uses the trained model 200 to output the extraction image IB of the feature of the weld estimated from the multiple input images IA1, IA2, and IA3. Therefore, the image processing system can extract the feature with high accuracy when the multiple input images IA1, IA2, and IA3 are input.

The welding system 10 according to the embodiment includes the welder 11 that welds the multiple welding members 21 and 22, the imaging device 15 that images the welding spot of the multiple welding members 21 and 22, the image processor 172 that uses the training model 200 to output the extraction image IB of the feature of the weld estimated from multiple images that are imaged by the imaging device 15, and the controller 173 that controls the welding device based on the feature extraction image IB output by the image processor 172. Therefore, the welding system 10 can control the welding operation with high accuracy by generating the feature extraction image IB based on the multiple input images IA1, IA2, and IA3.

### Second Embodiment

A second embodiment will now be described.

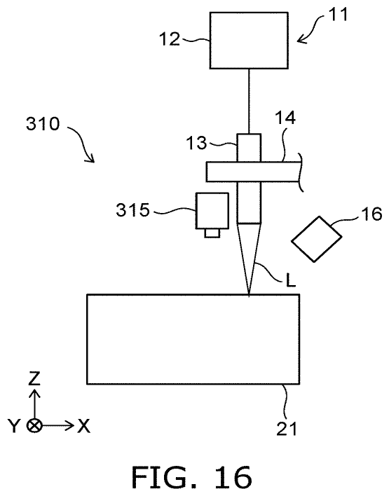

FIG. 16 shows a portion of a welding system according to the embodiment.

As a general rule in the following description, only the differences with the first embodiment are described. Other than the items described below, the embodiment is similar to the first embodiment.

According to the first embodiment, an example is described in which images that are included in the video image D imaged by the imaging device 15 are used as the control input images IA1, IA2, and IA3 and the training input images IC1, IC2, and IC3. Conversely, according to the embodiment, the welding system 310 includes an imaging device 315 that is configured to acquire multiple images in which the wavelength, the polarization, or the exposure time is different. There are cases where the positions of the feature are different from each other between the multiple images in which the wavelength, the polarization, or the exposure time is different. Then, the multiple images that are imaged by the imaging device 315 in which the wavelength, the polarization, or the exposure time is different may be used as the control input images IA1, IA2, and IA3 and the training input images IC1, IC2, and IC3.

The imaging device 315 may include filters that can transmit light of mutually-different wavelengths; and the imaging device 315 may acquire images that correspond to the filters. In such a case, one lighting device 16 may emit multiple light of mutually-different wavelengths; light in a wide band that includes multiple light of mutually-different wavelengths may be emitted; or light of mutually-different wavelengths may be emitted by providing multiple lighting devices 16. Also, the imaging device 315 may include polarizers that can transmit light of mutually-different polarization directions; and the imaging device 315 may acquire polarized images that correspond to the polarizers. The imaging device 315 may acquire a non-polarized image and a polarized image. In such cases, one lighting device 16 may emit multiple light of mutually-different polarization directions, or light of mutually-different polarization directions may be emitted by providing multiple lighting devices 16. Also, the imaging device 315 may include a shutter that is configured to acquire images having mutually-different exposure times; and the imaging device 315 may acquire images that correspond to the exposure times.

In such a case, the wavelength or the polarization of the multiple imaging devices are set so that the change amount of the position of the feature in the training input images IC1, IC2, and IC3 is less than the kernel size n1 of the multiple filters F11 to F1b of the input layer 211.

### Third Embodiment

A third embodiment will now be described.

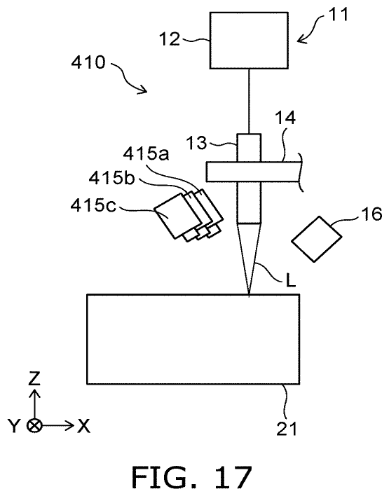

FIG. 17 shows a portion of a welding system according to the embodiment.

According to the embodiment, the welding system 410 includes multiple imaging devices 415a, 415b, and 415c; and the multiple imaging devices 415a, 415b, and 415c image the welding spot from mutually-different positions. The images that are imaged by the multiple imaging devices 415a, 415b, and 415c may be used as the control input images IA1, IA2, and IA3 and the training input images IC1, IC2, and IC3.

In such a case, the positions of the multiple imaging devices 415a, 415b, and 415c are adjusted so that the change amount of the position of the feature in the training input images IC1, IC2, and IC3 is less than the kernel size n1 of the multiple filters F11 to F1b of the input layer 211.

### Fourth Embodiment

A fourth embodiment will now be described.

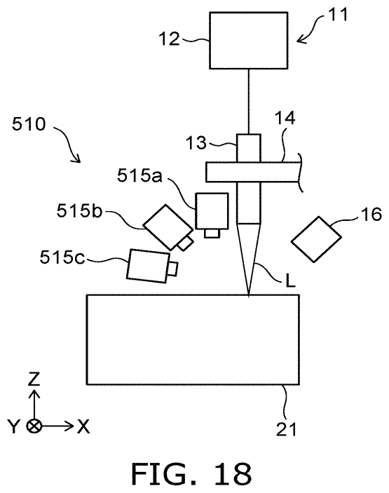

FIG. 18 shows a portion of a welding system according to the embodiment.

According to the embodiment, the welding system 510 includes multiple imaging devices 515a, 515b, and 515c; and the imaging angles of the multiple imaging devices 515a, 515b, and 515c are different from each other. The images that are imaged by the multiple imaging devices 515a, 515b, and 515c may be used as the control input images IA1, IA2, and IA3 and the training input images IC1, IC2, and IC3.

In such a case, the imaging angles of the multiple imaging devices 515a, 515b, and 515c are adjusted so that the change amount of the position of the feature in the training input images IC1, IC2, and IC3 is less than the kernel size n1 of the multiple filters F11 to F1b of the input layer 211.

As described above, the multiple training input images have mutually-different imaging conditions when imaging the welding spot. Although the imaging condition is not particularly limited, as described above, a time, a polarization direction of light, an imaging position, an imaging angle, a wavelength of light, an exposure time, etc., when imaging the welding spot are examples. Similarly, the multiple control input images have mutually-different imaging conditions when imaging the welding spot. Although a form is described in embodiments described above in which one imaging condition is different, multiple imaging conditions may be different.

Although a form is described in embodiments described above in which the imaging device images the welding spot when welding, the welding spot after welding may be imaged. When the welding spot after welding is imaged, for example, the image processing system may extract a weld bead or the like as the feature; and the feature extraction image that is output by the image processing system may be used to determine the accuracy of the weld, etc.

A form is described in embodiments described above in which the image processing system is realized by a control device of the welding system. However, the device that realizes the image processing system is not limited to that described above. The image processing system may be realized by an edge device that is accessory to the imaging device. The image processing system may be realized by a computer that processes images uploaded to a cloud. Also, the image processing system may be realized by multiple computers.

The image processing system is applicable to a system other than a welding system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Additionally, the embodiments described above can be combined mutually.

What is claimed is:

1. A method for generating a training model, the method comprising:
acquiring training data, the training data including
a plurality of training input images, and
a training feature extraction image in which a feature is extracted from one of the plurality of training input images; and
training a training model by using the training data,
the training model outputting an extraction image of the feature estimated from a plurality of input images,
the training model including an input layer that performs a convolution,
positions of the feature in the plurality of training input images being different from each other,
a change amount of the position of the feature in the plurality of training input images being less than a kernel size of a filter of the input layer.

2. The method according to claim 1, wherein
the training model includes an output layer that performs a convolution, and
the change amount is less than a kernel size of a filter of the output layer.

3. The method according to claim 1, wherein
the training model includes an intermediate layer that performs a convolution, and
the change amount is less than a kernel size of a filter of the intermediate layer.

4. The method according to claim 1, wherein
the training model includes an other intermediate layer that performs a deconvolution, and
the change amount is less than a kernel size of a filter of the other intermediate layer.

5. The method according to claim 1, wherein
the training model includes a U-NET.

6. The method according to claim 1, further comprising:
generating a plurality of preprocessed images before the training, the feature of the plurality of training input images being blurred in the plurality of preprocessed images,
the plurality of preprocessed images being input to the input layer in the training.

7. The method according to claim 6, wherein
in the generating of the plurality of preprocessed images, a level of blurring the feature in one training input image of the plurality of training input images is different from a level of blurring the feature in an other training input image of the plurality of training input images.

8. The method according to claim 1, wherein
an imaging condition when imaging an object spot is different between the plurality of training input images.

9. The method according to claim 8, wherein
the imaging condition when imaging the object spot is different between the plurality of training input images, and
the imaging condition includes at least one of a time, a polarization direction of light, an imaging position, an imaging angle, a wavelength of light, or an exposure time.

10. The method according to claim 1, wherein
the plurality of training input images is included in a video image of an object spot.

11. The method according to claim 1, wherein
the plurality of training input images is of a welding spot when welding, and
the feature is at least a portion of a contour of a molten pool, at least a portion of a contour of a keyhole, or at least a portion of a contour of a welding member.

12. An image processing method, comprising:
acquiring a plurality of input images; and
outputting an extraction image by using a trained model,
the extraction image being of a feature estimated from the plurality of input images,
the trained model including an input layer that performs a convolution,
the trained model being trained using training data,
the training data including
a plurality of training input images, and
a training feature extraction image in which the feature is extracted from one of the plurality of training input images,
positions of the feature in the plurality of training input 2 mages being different from each other,
a change amount of the position of the feature in the plurality of training input images being less than a kernel size of a filter of the input layer.

13. The method according to claim 12, wherein
a change amount of a position of the feature in the plurality of input images is less than the kernel size of the filter of the input layer.

14. An image processing system, comprising:
an image processor outputting an extraction image by using a trained model, the extraction image being of a feature estimated from a plurality of input images,
the trained model including an input layer that performs a convolution,
the trained model being trained using training data,
the training data including
a plurality of training input images, and
a training feature extraction image in which the feature is extracted from one of the plurality of training input images,
positions of the feature in the plurality of training input images being different from each other,
a change amount of the position of the feature in the plurality of training input images being less than a kernel size of a filter of the input layer.

15. A welding system, comprising:
a welder welding a welding member;
at least one imaging device imaging a welding spot of the welding member;
an image processor outputting an extraction image by using a training model, the extraction image being of a feature of a weld estimated from a plurality of images imaged by the imaging device; and
a controller controlling the welder based on a feature extraction image output by the image processor,
the trained model including an input layer that performs a convolution,
the trained model being trained by using training data,
the training data including
a plurality of training input images, and
a training feature extraction image in which the feature is extracted from one of the plurality of training input images,
positions of the feature in the plurality of training input images being different from each other,
a change amount of the position of the feature in the plurality of training input images being less than a kernel size of a filter of the input layer.
